(19) United States
(12) Patent Application Publication
(10) Pub. No.: US 2023/0091436 A1
(43) Pub. Date: Mar. 23, 2023

(54) ADDITIONAL SEAT STRUCTURE FOR ELECTRIC BICYCLES

(71) Applicant: CESAR AUGUSTO DE MELLO RIPPEL, Curitiba (BR)

(72) Inventor: CESAR AUGUSTO DE MELLO RIPPEL, Curitiba (BR)

(21) Appl. No.: 17/951,286

(22) Filed: Sep. 23, 2022

(30) Foreign Application Priority Data
Sep. 23, 2021 (BR) 10 2021 018953-3

(51) Int. Cl. B62J 1/14

(52) U.S. Cl. CPC B62J 1/14

(57) ABSTRACT

The present invention relates to an additional seat structure for electric bicycles (100) comprising a right main rod (200) and a left main rod (300), wherein each main rod (200, 300) comprises a first straight region (201, 301) and a second straight region (203, 303) with faces essentially parallel to each other, and between which there is at least one transition region (202, 302).

### TECHNICAL FIELD

The present invention pertains to the field of mechanical engineering and means of transport, notably of seat structures specially adapted for accommodating people in vehicles.

### INTRODUCTION

The present invention relates to an additional seat structure for electric bicycles, more specifically for electric bicycle models intended for use both on regular roads and terrain and on mountainous and rough roads and terrain, widely known as “mountain bikes” and the like.

### BACKGROUND OF THE INVENTION

Most bicycles are designed to be used by one person sitting on a saddle or the like, while some models even have luggage racks or rumps that allows one to carry an extra person, as well as baskets and other cargo accessories. However, these models are intended for people of adequate size for the bicycle size, with no space to safely transport small children or small people.

To solve this issue, there are several types of auxiliary seats that can be mounted on the front and rear part and also in the middle part of the bicycle, being equipped with parts, pieces, fixing elements for their installation in structural elements of the bicycle.

These solutions need to be stable and firm to withstand abrupt changes in direction, vibrations, and bumps, offering comfort and safety for both the child and the bicycle rider, without interfering with the use or performance of the bicycle, whereby solutions of seats trapped between the top tube and the down tube are the most suitable to meet these conditions. In addition, the auxiliary seats need to be adaptable to as many bicycle models and sizes as possible, a characteristic that becomes an even greater challenge for electric bicycle models that are usually equipped with batteries and other components having side flares arranged inside the frame.

Finally, it is also desirable for auxiliary seats to be practical in their assembly and disassembly and also have a low manufacturing cost.

### PRIOR ART

Known prior art solutions for Mountain Biking child seats in the nature discussed herein can be verified in prior art documents such as the Brazilian document BR2020200203202, entitled “Estrutura de assento adicional para bicicletas”, which discloses a seat comprising a right side rod and a left side rod, joined at their lower ends to a lower shaft equipped with regulating nuts and, at their upper ends, to a pad by means of adjustment rails pierced by screws that also pierce the pad and are fixed with nuts, in which the pad is topped by a saddle and bears a tightening shaft that moves the pad upward or downward.

Document BR2020200203202, despite providing for the regulation of the rod openings, does not provide rods capable of allowing the installation of the seat in different models for different sizes of bicycle frames, including electric bicycles. In addition, the connection of the rods at their upper ends is made by two screws with two nuts at each end and which pierce both the adjustment rails and the pad itself. Therefore, opening regulation is only possible by loosening at least two of the four nuts and, as the pad is made of resilient material and there are two through screws, rods adjustment (distance or approximation) is difficult because it depends on the parallelism of the rods, screws and through holes of the pad, thus being able to stack and require force for the regulating action. Thus, with each new adjustment, at least two screws must be loosened, and the movement of the rods depends on the positioning of the pad. Finally, the inner lining of the rods is made of rubber sheets that, if not fixed with adhesive to the rods, can come loose or move, which can scratch or damage the bicycle and even hurt the child in the auxiliary seat.

Another patent document whose solution can be mentioned is WO200847131, entitled “Pedal powered vehicle with auxiliary seat for a child”, which describes a kit for assembling a child's auxiliary seat in a pedal powered vehicle of the type comprising a structure with a seat tube for assembling a saddle.

However, WO200847131 also does not describe or suggest flexibility conditions for the use of the seat in the electric bicycles frame, in addition to the structure, fixing and adjustment depending on numerous parts, including uncomfortable long rails that replace or overlap the top tube of the frame.

Finally, it is worth mentioning that several prior art solutions can be verified in other patent documents such as U.S. Pat. No. 5,927,801, CN107176234, and CN209410225U. In these documents, auxiliary seats for children are also verified, but sufficient versatility characteristics to fit in electric bicycle models are not verified, nor are the adjustment conditions that depend on a single action with a tool, which require little effort for installation and regulation movements.

The prior art does not provide economical, versatile solutions, with great stability and safety for both the child and the bicycle rider, which are easy to install and do not require manual dexterity in the installation, nor the use of more than one tool. Furthermore, the prior art is full of solutions that use bars or rods fixed under the saddle of the main bicycle and even seats mounted on the rear of the bicycle or even on the front wheel. Some compromise the passage of brake cables and gear shifting, and almost all of them require adaptations and the use of more complex tools. Notably, there are also rear seat solutions that additionally change the bicycle's center of gravity, compromising the stability and safety of both the main bicycle user and the child.

There is therefore space for an additional child seat, especially for a seat that:
a) Can be used on electric bicycles that have batteries and other components with side flares arranged inside the frame;
b) Can be safely attached and fixed regardless of the type of top or down tube or frame of the electric bicycle;
c) Be stable against tipping over and/or pivoting;
d) Support and protect users' lower limbs;
e) Be quick and simple to assemble and disassemble;
f) Waive the use of several tools for its installation;
g) Incorporate low material and manufacturing cost; and
h) That does not alter the intended mechanical, dimensional, and usage characteristics of the electric bicycle.

Goals

One of the objects of the present invention is providing a seat structure for electric bicycles according to the characteristics of claim 1 of the appended set of claims.

### DESCRIPTION OF THE FIGURES

For a better understanding and visualization of the subject matter of the present invention, it will now be described with reference to the appended figures, representing the obtained technical effect, in which:

FIG. 1: shows a perspective view of an additional seat structure for electric bicycles according to the present invention;

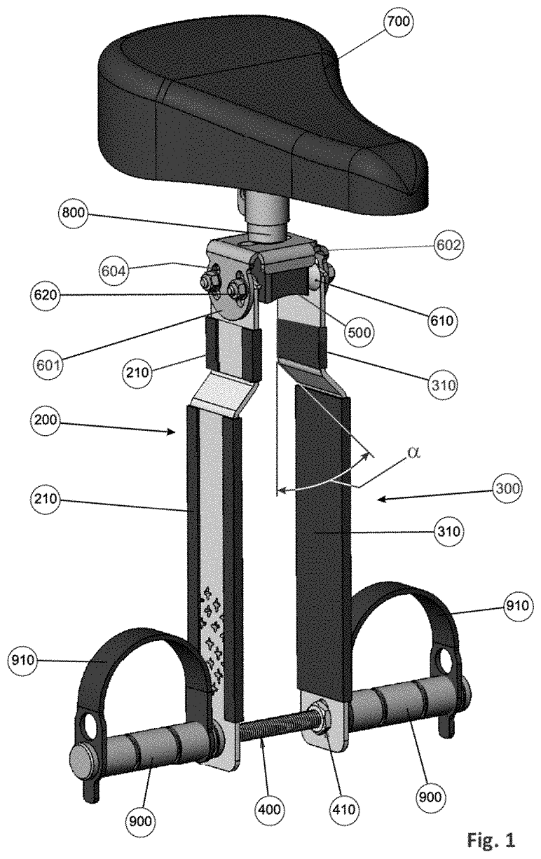

FIG. 2: shows an exploded perspective view of the seat in FIG. 1;

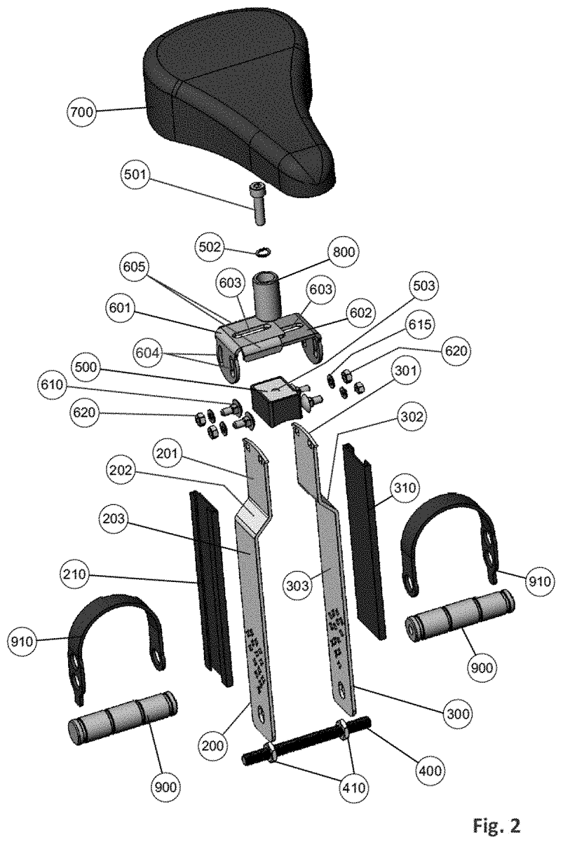

FIG. 2a: shows a side view of a fitting cylinder, according to the present invention; and

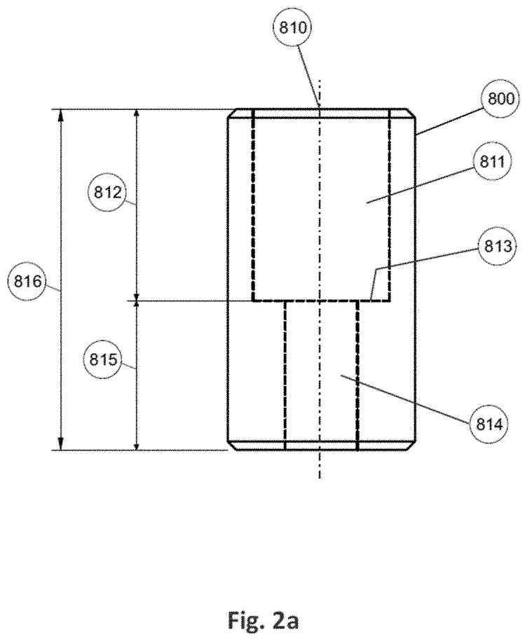

FIG. 3: shows the seat in FIG. 1 installed on an electric bicycle.

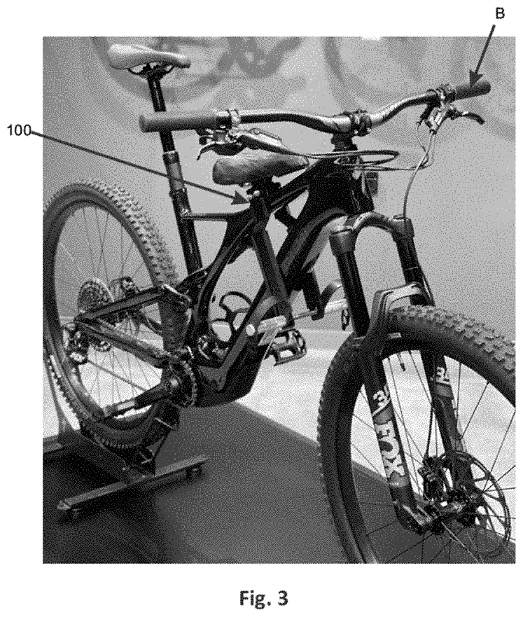

### DETAILED DESCRIPTION OF THE INVENTION

The additional seat structure for electric bicycles (100) or simply structure (100), according to the present invention, comprises a right main rod (200) and a left main rod (300), essentially parallel to each other and connected at their lower ends to a lower shaft (400) provided with adjustment nuts (410) and at their upper ends to a pair of “L”-shaped adjustment rails, whereby an upper adjustment rail (601) and a lower adjustment rail (602) are each provided with at least one straight oblong hole (603) arranged on its sides parallel to the horizontal plane and arched oblong holes (604) on their sides (or sides parallel to the vertical plane).

The upper adjustment rail (601) has downwardly curved flanges (605) that linearly guide the relative movement between the adjustment rails (601, 602), whereby relative movement is possible only in a direction parallel to the longitudinal axis of the oblong holes (603) and occurring without stacking, thus keeping the oblong holes (603) always aligned.

The upper ends of the main rods (200, 300) are fixed to the sides of the adjustment rails (601, 602) by fixing elements that can be, without limitation, mechanical fixing elements such as screws (610), washers (615), nuts (620), rivets, clamps, welds, and the like with robustness suitable for the application. The arched oblong holes (604) are curved, allowing for positional and angular adjustment of the side rods (200, 300). The present structure (100) therefore allows the adjustment of the saddle inclination (700) so that it is parallel to the ground through the saddle ratchet inclination which is independent of the pad position (500).

The set of rods (200, 300) and adjustment rails (601, 602) are arranged on the pad (500) so that the upper adjustment rail (601) is above the lower adjustment rail (602) and that the straight oblong holes (603) and the threaded hole (503) of the pad (500) are aligned and allow the passage of one pad screw (501), preferably provided with a simple washer or, preferably, spring washer (502) to withstand the vibration and impacts from the use, in which the pad screw (501) is surrounded by a fitting cylinder (800) and screwed into the threaded hole (503) of the pad (500). By tightening the pad screw (501), both sets are fixed at the same time at the pad (500), thus making it possible to fix the structure (100) on the top tube of the frame, in which the saddle (700) is arranged on the fitting cylinder (800).

The fitting cylinder (800) is preferably a cylindrical element, provided with a through hole (810) which has a larger diameter hole (811) and depth (812) and a smaller diameter hole (814) and depth (815), wherein in the traversing region between the larger diameter hole (811) and the smaller diameter hole (814) form an annular seat (813), which provides the head abutment of the pad screw (501) and one or more washers (502). The depth (812) is equivalent to a value between 40 and 70%, preferably between 50 and 60% of the total length (816) of the fitting cylinder (800) to allow access to a tightening tool and ensure that the pad (501) can be inserted/threaded into the threaded hole (503) to a depth equal to at least 2.5 times its diameter.

The positioning of the pad (500) is independent of the adjustment and positioning of the upper (601) and lower (602) adjustment rails, in which the set is tightened by only one pad screw (501), ensuring accuracy in the adjustment, better abutment of the main rods (200, 300) to the tubes or components of the frame, providing a structure (100) that adapts to different tubes sizes of the bicycle frames (B) and that exerts sufficient pressure on one or more tubes of the bicycle frame (B), eliminating the need for a counter-attachment piece below the top tube.

So, the main set of rods (200, 300), upper (601) and lower (602) adjustment rails, fitting cylinder (800), and pad (500) are held together by a single pad screw (501).

The lower shaft (400) is perpendicularly installed, extending beyond the main rods (200, 300), supporting two foot supports (900) each provided with a safety clip (910).

Each main rod (200, 300) comprises a first straight region (201, 301) and a second straight region (203, 303), with faces essentially parallel to each other, and between which there is at least one transition region (202, 302) shaped to increase the distance between these parallel faces. The distance between the second straight regions (203, 303) is different and preferably greater than the distance between the first straight regions (201, 301), while the second straight regions (203, 303) length is also different and preferably greater than the first straight regions (201, 301) length.

The transition region (202, 302) can be curved and/or inclined with respect to the parallel faces of the main rods (200, 300) forming an angle (α) which can vary from 1° to 90°, being preferably from 20° to 70° and more preferably from 30° to 60°.

The main rods (200, 300) therefore have a greater distance from each other in the second straight regions (203, 303), thus making it possible to circumvent batteries and other components with side flares arranged inside the electric bicycle frame (B). In addition, the first straight regions (201, 301), the second straight regions (203, 303) and, eventually, the transition regions (202, 302) have their inner faces, facing the frame, covered by rubber rails (210, 310) which, in addition to protecting the bicycle parts (B) and the main rods (200, 300), allow the backrest with damping, reducing or avoiding noises caused by friction between the parts.

Note that the main rods (200, 300) can also have more than one transition region (202, 302).

It is also worth noting that the main rods (200, 300) can also be straight or continuous, free from transition regions (202, 302), keeping the same fixing and fitting system in the top tube of the bicycle frame (B).

For the correct assembly, positioning, adjustment and fixing of the structure (100) on a bicycle frame (B), the distance between the main rods (200, 300) is first adjusted by sliding at least one of the adjustment rails (601, 602), whereby the distance is varied according to the dimensions of the top tube and/or the down tube and/or the frame and, especially on electric bicycles (B), according to the dimensions of the batteries and other components with side flares arranged inside the frame. After this width adjustment, the pad screw (501) is tightened. This pad screw (501), arranged inside the fitting cylinder (800), ensures contact and pressure maintenance of the main rods (200, 300) and pad (500) against the top tube of the bicycle frame (B) and the main rods (200, 300) against the bicycle's down tube (B) or another component. As already shown, the positioning of the main rods (200,300) does not interfere with the positioning of the pad (500).

After that, the lower shaft (400) is placed at the bottom of the second straight regions (203, 303) whereby the adjustment nuts (410) are rotated until they abut the inner part of the parallel faces of the second straight regions (203, 303).

The safety clips (910) are fitted to the foot supports (900) for the child's feet and the foot supports (900) are threaded into the lower shaft ends (400). After threading the foot supports (900), the counter-tightening is performed with the adjustment nuts (410) to better secure the foot supports (900) and dimensional stabilization of the set.

The saddle (700) is placed fixed on the fitting cylinder (800), and height adjustment can be made according to the need until the best positioning is achieved. After this operation, the child can be comfortably accommodated on the saddle (700), and the safety clips (910) must be adjusted on the child's feet, in which the child can hold on to the bicycle's handlebars.

In particular, the material of the side rods (200, 300) must be chosen, in a non-limiting way, from the group of metals and their alloys, which can be carbon steel, aluminum, synthetic materials with or without fiber and other materials with robustness and resilience characteristics suited to the application.

The material of the pad (500) and the rubber rail (210, 310) must be resilient and preferably made of rubber, which may be synthetic or natural rubber, or composite, or a combination thereof, and may also be another material with appropriate and similar characteristics, as long as it allows tightening the sets and minimum damping.

The present structure (100) can be used in a wide variety of electric bicycles and conventional bicycles and can be used by children of 2 to 5 years old. The positioning of the structure (100) between the bicycle saddle and the handlebars allows the child to be between the arms of the adult, facilitates the care of smaller children during the rides and allows the child to have the same visibility as the adult during the ride.

The present structure (100) allows the child to enjoy a ride with their parents or guardians while they still do not have the knowledge and possibility of using their own bicycle.

### Final Remarks

It is clear that the measures and ratios between measures described for the present invention may vary according to the dimensioning of the structure.

Exhaustive practical tests, however, have shown that the said dimensions and their relations are highly efficient and effective in the construction of traction elements of the nature discussed herein, whereby measures and their ratios are highly reliable and reproducible.

### CONCLUSION

It will be easily understood by one skilled in the art that modifications can be made to the present invention without departing from the concepts set out in the description above. Such modifications should be considered as included within the scope of the present invention. Consequently, the particular embodiments previously described in detail are merely illustrative and exemplary, and non-restrictive in terms of the scope of the present invention, to which the full extent of the accompanying claims should be given, in addition to all and any equivalents thereof.

1. An additional seat structure for bicycles, characterized in that it comprises a right main rod (200) and a left main rod (300), wherein each main rod (200, 300) comprises a first straight region (201, 301) and a second straight region (203, 303) with faces essentially parallel to each other, and between which there is at least one transition region (202, 302).

2. The seat structure according to claim 1, characterized in that the main rods (200, 300) are joined at their upper ends to adjustment rails (601, 602) provided with straight oblong holes (603), wherein the set of rods (200, 300) and adjustment rails (601, 602) are arranged on a pad (500) with the upper adjustment rail (601) arranged on the lower adjustment rail (602), with the straight oblong holes (603) and the threaded hole (503) of the pad (500) aligned for the passage of a pad screw (501), screwed into a threaded hole (503) of the pad (500).

3. The seat structure according to claim 1, characterized in that the set of main rods (200, 300), upper (601) and lower (602) adjustment rails, fitting cylinder (800) and pad (500) are secured by a single pad screw (501).

4. The seat structure according to claim 3, characterized in that the fitting cylinder (800) comprises a through hole (810) with a larger diameter hole (811) and depth (812) and a smaller diameter hole (814) and depth (815), wherein in the region of passage between the larger diameter hole (811) and the smaller diameter hole (814) an annular seat (813) is formed, which provides the head abutment of the pad screw (501) and of one or more washers (502).

5. The seat structure according to claim 4, characterized in that the depth (812) is equivalent to a value between 40 and 70%, preferably between 50 and 60% of the total length (816) of the fitting cylinder (800).

6. The seat structure according to claim 1, characterized in that the upper adjustment rail (601) has downwardly curved flanges (605) that form guides to linearly drive relative movement between the adjustment rails (601, 602).

7. The seat structure according to claim 1, characterized in that the length of the second straight regions (203, 303) is also different and preferably greater than the length of the first straight regions (201, 301).

8. The seat structure according to claim 1, characterized in that the distance between the second straight regions (203, 303) is different and preferably greater than the distance between the first straight regions (201, 301).

9. The seat structure according to claim 1, characterized in that the main rods (200, 300) may also be straight or continuous, free of transition regions (202, 302).
